(19) United States
(12) Patent Application Publication
(10) Pub. No.: US 2002/0118227 A1
(43) Pub. Date: Aug. 29, 2002

(54) Graphical user interface

(75) Inventor: Berardino Salvatore, Silvi (IT)

Correspondence Address: IBM Corp, IP Law, 11400 Burnett Road, Zip 4054, Austin, TX, 78758, US

(73) Assignee: International Business Machines Corporation

(21) Appl. No.: 09/920,404

(22) Filed: Aug. 2, 2001

(30) Foreign Application Priority Data
Feb. 24, 2001 (GB) 0104760.4

(51) Int. Cl. G09G 5/00

(52) U.S. Cl. 345/764

(57) ABSTRACT

In a window oriented graphic user interface, a method for controlling the opening a new window, minimizing the loss of visibility of the existing objects.

When a user needs to open a new window on a desktop, the position and dimensions of the new window can be selected so that it does not completely cover the existing objects already on the desktop. According to a preferred embodiment of the present invention the user, before opening a new window, can select an area on the desktop where the window will be displayed, so that the user can decide which windows or portion of windows must be visible after the new window is displayed on the desktop. An advantage of the present invention is that the above result is obtained without the need of a succession of manual adjustments after the window has been opened.

### FIELD OF INVENTION

The present invention relates to a graphical user interface and particularly to a system and method for arranging the windows on a graphical user interface.

### BACKGROUND OF THE INVENTION

Data processing systems are usually provided with a graphical user interface (GUI) to allow a user to control the data processing system and to present the results of user actions on the system display. In a graphical user interface, applications and data are generally presented as objects depicted on a user interface. A user is then provided with a graphical, intuitive interface to a complex data processing system which permits graphic selection of depicted objects and manipulation of applications corresponding to those objects.

It is usually possible to simultaneously execute several software applications. The execution of multiple applications simultaneously is often referred to as “multitasking”. It is desirable in such environments to allow the user to view some or all of the applications simultaneously. This is often accomplished by the utilization of the concept of “windows” wherein all or part of multiple applications are displayed in separate viewports of a computer system video display system. It is known to have multiple software applications running on a computer simultaneously, one or more of which may be active at any given time, and which may have an associated window or icon be displayed.

There may be several windows simultaneously present on the desktop with each window displaying information that is generated by a different application program. Each application program presents information to the user through its window by drawing images, graphics or text within the window region. The user, in turn, communicates with the application by pointing at graphical objects in the window with a pointer that is controlled by a pointing device, such as a mouse, and then selecting the objects, or by typing information via a keyboard associated with the monitor. Selection of the objects may be effected by actuating the mouse to move the pointer onto or near the objects and pressing and quickly releasing, i.e. clicking, a button on the mouse, or by manipulating a cursor via the keyboard.

These user interface objects may be easily manipulated utilizing a standard set of interface commands. For example, the user may move the windows around on the display screen, change their sizes and appearances, shrink down a window to a so-called icon, rearrange the objects with respect to their relative background/foreground position so as to arrange the desktop in a convenient manner, etc.

There are a number of different graphical user interface environments commercially available which utilize the arrangement described above. These environments include the System 7 operating system developed by Apple Computer, Inc. (System 7 is a trademark of Apple Computer, Inc.), the Windows graphical user interface developed by the Microsoft Corporation (Windows is a trademark of Microsoft Corporation) and the OS/2 Presentation Manager developed by International Business Machines Corporation (OS/2 and Presentation Manager are trademarks of International Business Machines Corporation).

A problem in a graphical user interface is that when several applications are opened simultaneously, the desktop may assume a cluttered appearance. Some of the windows can overlay other windows, or other graphical elements, such as icons, which are displayed on the desktop. Therefore the user needs to move the foreground windows to operate on hidden elements.

It is known in graphical user interfaces to provide automated techniques, which avoid the need to manually arrange each single window. It is also known from EP-A-820000 to move hidden icons or windows to visible locations of the desktop when they are obscured by other windows, or other desktop objects. The solution suggested by EP-A-820000 has the drawback of changing the position of some existing objects when new windows are opened.

This might be annoying for a user who can normally rely upon the usual position of some objects, particularly the application icons. It would be desirable for the user to be able to select the position and the dimensions of a new window to be opened on the desktop, in order to minimise the impact this new window has on the existing objects.

It is an object of the present invention to provide a technique which overcomes the above drawbacks.

### DISCLOSURE OF THE INVENTION

According to the present invention we provide, in a computer system having a graphic user interface for displaying a plurality of objects on a desktop, a method for controlling the displaying of new objects on the desktop comprising the steps of:

detecting a user request for displaying a new object on the desktop;

responsive to user selection, determining a target area on the desktop;

displaying the new object within the target area.

Also, according to the present invention, we provide a computer program including program code means adapted to perform the steps of the above method when the program is run on a computer.

Furthermore, according to the present invention we provide, in a data processing system, a graphical user interface comprising:

means for detecting a user request for displaying a new object on the desktop;

means for, responsive to user selection, determining a target area on the desktop;

means for displaying the new object within the target area.

### BRIEF DESCRIPTION OF THE DRAWINGS

Various embodiments of the invention will now be described in detail by way of examples, with reference to accompanying figures, where:

FIG. 1 shows schematically a computer which may be utilized to implement the method and system of the present invention;

FIG. 2 shows schematically a graphical user interface used for the preferred embodiment of the present invention; FIGS. 3a-3d show schematically the opening of a new window on a desktop according to a preferred embodiment of the present invention.

FIG. 4 shows a diagram of the method steps according to a preferred embodiment of the present invention.

### DESCRIPTION OF THE PREFERRED EMBODIMENTS

With reference to FIG. 1, there is depicted a computer 100 which may be utilized to implement the method and system of the present invention. The computer 100 preferably includes a display unit 110 and a keyboard 120, coupled in a manner well known in the art. Additionally, the computer 100 includes a processor system unit 130 which may serve to mount a fixed disk drive and a diskette drive in addition to the main processor and memory. Further, in order to facilitate the utilization of a graphical user interface, computer 100 preferably includes a graphic pointing device, such as a mouse 140, which may be utilized to manipulate the position of a pointer (not shown) within a visual display on the screen 110. Those skilled in the art will appreciate that computer 100 may be implemented utilizing any state-of-the-art personal computer, such as the personal computers manufactured by International Business Machines Corporation.

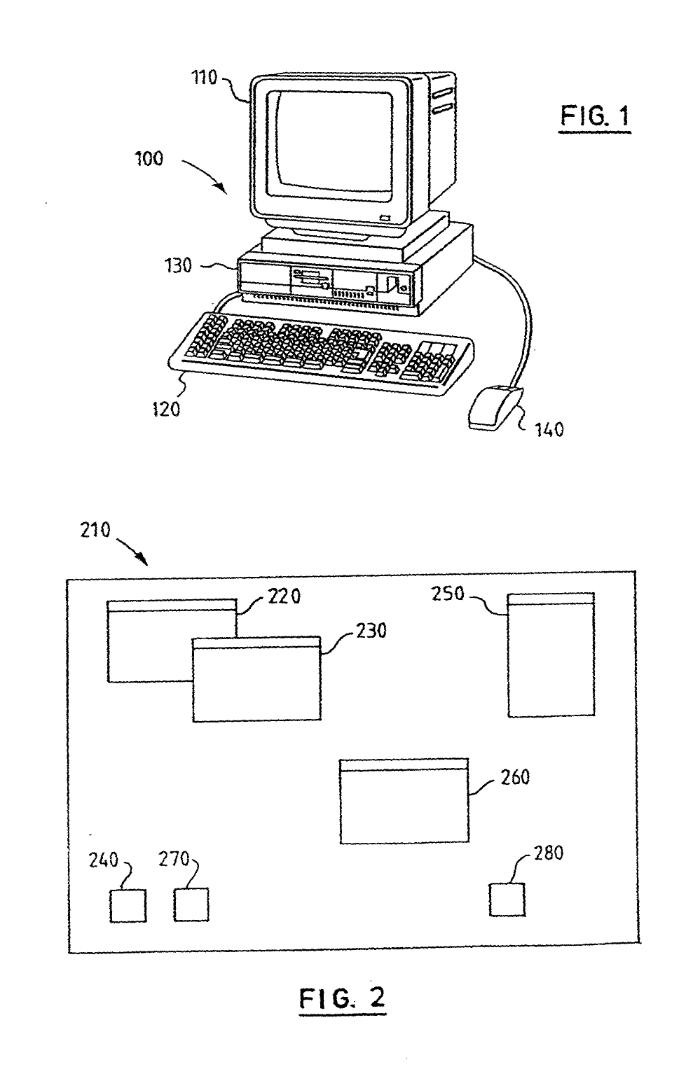

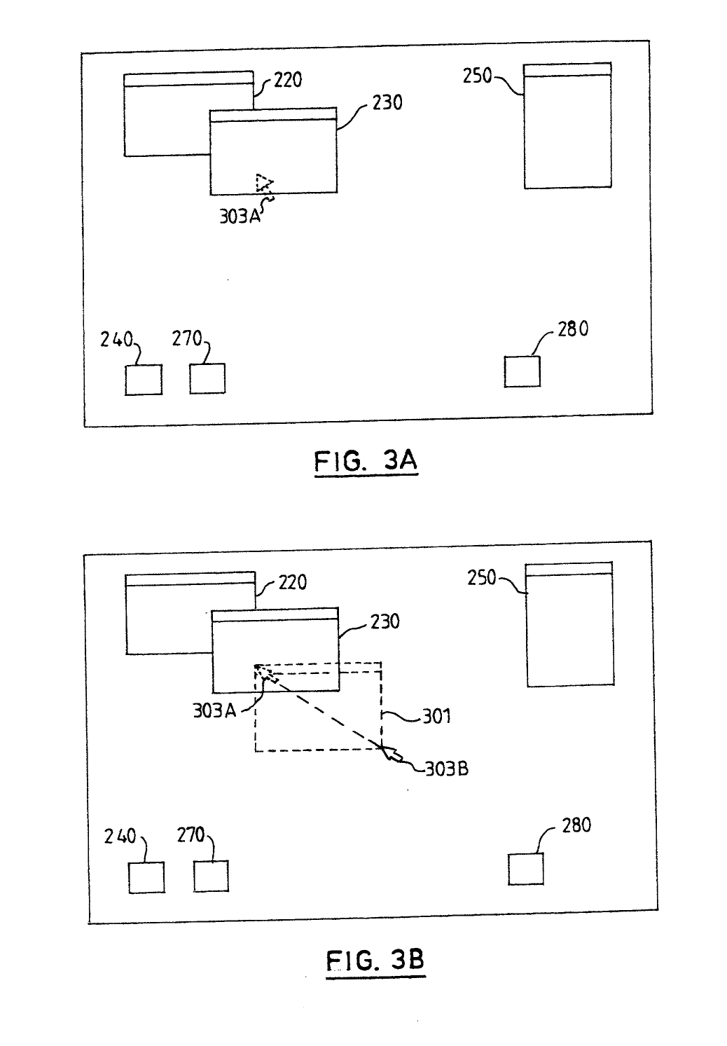

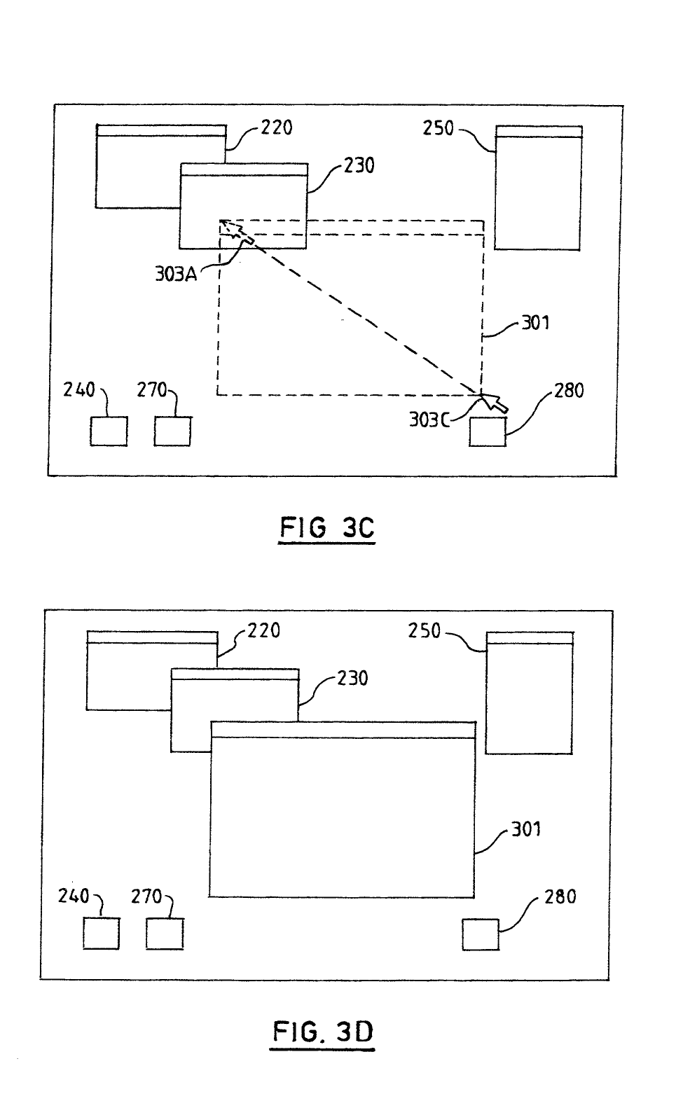

With regard now to FIG. 2, a graphical user interface which may be utilized to implement the method and system of the present invention is shown. The graphical display is typically arranged to resemble a single desktop 210. Execution of an application program involves one or more user interface objects represented by windows 220, 230 and icons 240. Typically, there may be several other windows 250, 260 and icons 270, 280 simultaneously present on the desktop and displaying information that is generated by different applications.

The window environment is generally part of the operating system software that includes a collection of utility programs for controlling the operation of the computer system 100. The operating system, in turn, interacts with application programs to provide higher level functionality, including a direct interface with the user. Specifically, the application programs make use of operating system functions by issuing task commands to the operating system which then performs the requested task. For example, an application program may request that the operating system display certain information on the window 220 for presentation to the user.

When a user needs to open a new window on a desktop such as the one represented in FIG. 3a, he might wish to position the new window so that it does not cover the existing objects already on the desktop, or a portion of them. With the systems available on the market, this operation is possible only through a succession of manual adjustments after the window has been opened and automatically placed by the system in a predefined position. The following steps must be performed:

open the window (e.g. by launching a new application, or exploding an icon);

moving the window to the desired position by means of a pointing device; this can be done for example by operating a mouse and placing the cursor inside the window area, then, with the predefined mouse functions the window can be hooked and dragged to the desired position;

resizing the window to the desired dimensions; again this operation can be usually done by operating a cursor by means of a mouse and its predefined functions of hooking and dragging.

According to a preferred embodiment of the present invention the user, before opening a new window, can select an area on the desktop where the window will be displayed, so that the user can decide which windows or portion of windows must be visible after the new window is displayed on the desktop. With reference to FIG. 3a to FIG. 3d the method according to a preferred embodiment of the present invention is described. FIG. 3a shows a desktop having windows 220, 230 and 250 and icons 240, 270 and 280. A user wishing to open a new window can move the cursor (e.g. by means of a mouse) to position 303a. This position is then selected as the top left corner of the new window to be opened. As shown in FIG. 3b and 3c the cursor is “dragged”, e.g. by means of a mouse, across the desktop until the final position 303c is reached. This final position 303c is then selected as the bottom right corner of the area 301 where the new window will be displayed. In this way the new window is displayed on the desktop so that the coverage of existing objects interesting for the user can be minimised at user's discretion. It is evident that other ways of identifying the area 301 on the desktop could be used instead (e.g. different opposite corners, the center of the window and the size).

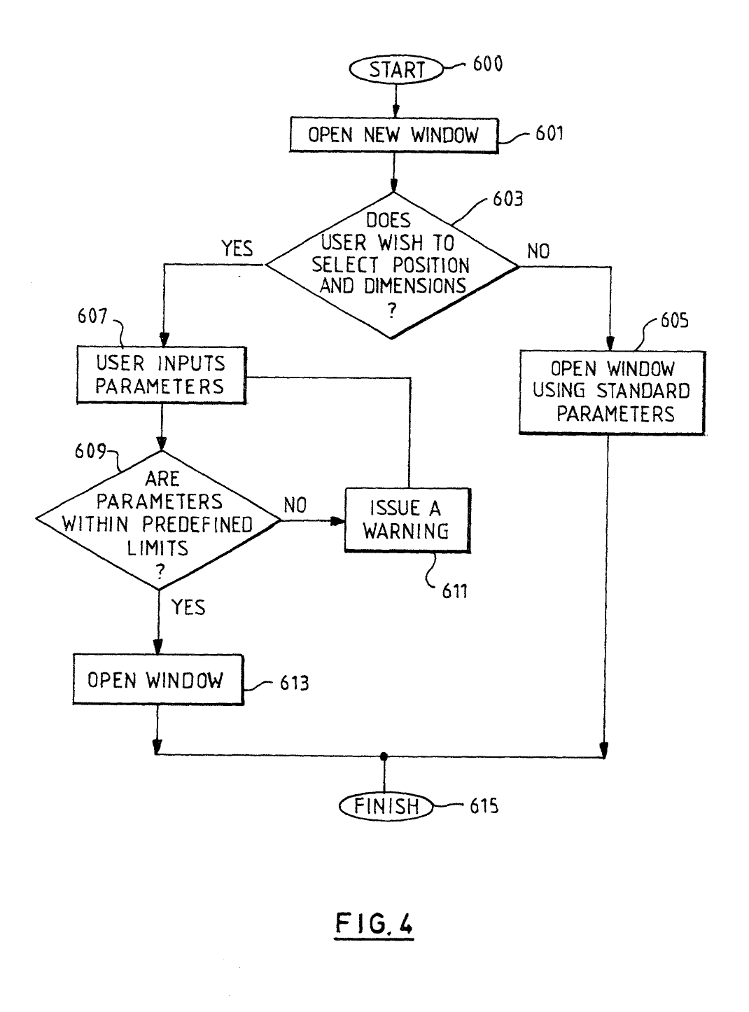

FIG. 4 shows a diagram representing the method steps according to a preferred embodiment of the present invention. The process starts at step 600; after the user requests to open a new window 601 (or to explode an existing minimized window), the system offers the choice of selecting the position and dimensions which will be occupied by the window (step 603). If the user does not express the intention of defining the position and dimension of the new window, the system opens the window using predefined standard parameters (605). Otherwise the system receives user's input (607) and checks the user's selection (609): if the size requested by the user does not respect the minimum and maximum predefined limits, the system issues a warning forcing the user to stay within those limits (step 611) and the control goes back at step 607. At step 613 the system opens the window and the process ends (615).

A possible alternative is that some of the above described steps coincide. Furthermore, the user's selection of position and size, can be implemented through software only, as mentioned above, or alternatively for example an additional button could be added to the mouse, with which to identify the desired parameter before or after requesting the opening of a new window.

Those skilled in the art will appreciate that the operations of the method described above may be done either by embedding the method steps into the operating systems or with applications using the functions offered by the state of the art operating systems. As an example, the operating systems Windows95 and Windows98 of Microsoft Corp. have a set of APIs (Application Program Interfaces) which can be used to control the position and the size of objects on the desktop and to detect mouse events. Examples of useful API provided by Windows98 are CreateWindowEx( ) and RegisterClassEx( ). Mouse events are identified e.g. By the following Windows constant:

WM_CAPTURECHANGED

WM_LBUTTONDOWN

WM_BUTTONDOWN

WM_RBUTTONDOWN

WM_MOUSEMOVE

What is claimed is:

1. In a computer system having a graphic user interface for displaying a plurality of objects on a desktop, a method for controlling the displaying of new objects on the desktop comprising the steps of:
detecting a user request for displaying a new object on the desktop;
responsive to user selection, determining a target area on the desktop;
displaying the new object within the target area.

2. The method of claim 1 wherein the target area is rectangular and the user selection includes:
selecting a first corner of the target area;
selecting the corner opposite to the first corner.

3. The method of claim 2 wherein the user selection includes moving a pointer on the desktop by means of a pointing device.

4. A computer program including program code means adapted to perform the steps of claim 1 when the program is run on a computer.

5. A window oriented operating system including program code means for performing the method of claim 1.

6. A graphical user interface comprising:
means for detecting a user request for displaying a new object on the desktop;
means for, responsive to user selection, determining a target area on the desktop;
means for displaying the new object within the target area.
